(19) United States
(12) Patent Application Publication
(10) Pub. No.: US 2025/0037224 A1
(43) Pub. Date: Jan. 30, 2025

(54) PROCESS FOR SCALED DETECTION & INFLUENCING OF EMPLOYEE MINDSETS AND AUTOMATING RECOMMENDATION OF APPROPRIATE SUPPORT & DEVELOPMENT SERVICES

(71) Applicant: SAUDI ARABIAN OIL COMPANY, Dhahran (SA)

(72) Inventors: Dorota A. Karas, Addlestone (GB); Mohammed A. Alabbad, Dammam (SA); Serkan Dursun, Dhahran (SA)

(73) Assignee: SAUDI ARABIAN OIL COMPANY, Dhahran (SA)

(21) Appl. No.: 18/358,839

(22) Filed: Jul. 25, 2023

(51) Int. Cl. G06Q 50/20; G06F 3/147; G06F 21/31

(52) U.S. Cl. CPC G06Q 50/2057; G06F 3/147; G06F 21/31

(57) ABSTRACT

A method for bi-directional communication using a standby screen is disclosed. The method includes displaying, within the standby screen displayed on each of a number of computing devices of an organization, a message that prompts a user-specific response from each user of the organization, receiving, in response to displaying the message and from the computing devices, the user-specific response from at least one responding user, generating a result by at least analyzing the user-specific response from the at least one responding user, and dynamically adjusting the message for subsequent displaying within the standby screen to prompt a subsequent user-specific response from each of the users.

### BACKGROUND

In a typical organization, an employee may not be aware of what development services are available to them, and/or what intervention may be most appropriate for them at a given time, and/or where and how to access these resources. The development service is any service available within the organization to facilitate the employees to perform work assignments and/or to improve employees' contributions to target results of the organization. Assessing and recommending development services based on individual needs at the right time is more effective than an off-the-shelf approach. However, delivery of individual recommendations by human resource advisors can be constrained by limited resources, particularly in medium and large sized corporations.

A screensaver is a computer program that blanks the display screen or fills the display screen with moving images or patterns when the computer has been idle for a designated time. The displayed image or pattern is referred to as a screensaver image. The screensaver image may be dynamic (e.g., video images) or static (e.g., a still picture). The static screensaver image is also referred to as a wallpaper or a computer display background. The screensaver was originally to prevent phosphor burn-in on a cathode-ray-tube (CRT) used as a computer display. A home screen or start-up screen is the main screen on a computer where the user can launch an application or use it for other purposes. A lock screen is a screen on a computer that displays when the user lock the screen or when the computer is in a sleep mode. Throughout this disclosure, the screensaver image, lock screen, home screen, start-up screen, and/or computer display background are collectively referred to as a standby image. One or more type of the standby images may be set up to offer a basic layer of security by requiring a user to enter a password to re-access the computer.

### SUMMARY

In general, in one aspect, the invention relates to a method for bi-directional communication using a standby screen. The method includes displaying, within the standby screen displayed on each of a plurality of computing devices of an organization, a message that prompts a user-specific response from each of a plurality of users of the organization, receiving, in response to displaying the message and from the plurality of computing devices, the user-specific response from at least one responding user of the plurality of users, generating a result by at least analyzing the user-specific response from the at least one responding user, and performing, based on the result, a feedback operation of the organization, wherein the feedback operation comprises dynamically adjusting the message for subsequent displaying within the standby screen to prompt a subsequent user-specific response from each of the plurality of users.

In general, in one aspect, the invention relates to a system for bi-directional communication using a standby screen. The system includes a computer network of an organization that broadcasts a standby screen template to a plurality of computing devices of an organization, the plurality of computing devices coupled to the computer network and comprising functionality for displaying, based on the standby screen template, a standby screen on each of the plurality of computing devices, displaying, within the standby screen, a message that prompts a user-specific response from each of a plurality of users of the organization, and receiving, in response to displaying the message and from the plurality of computing devices, the user-specific response from at least one responding user of the plurality of users, and an artificial intelligence (AI) platform comprising functionality for generating a result by at least analyzing the user-specific response from the at least one responding user, and performing, based on the result, a feedback operation of the organization, wherein the feedback operation comprises dynamically adjusting the message for subsequent displaying within the standby screen to prompt a subsequent user-specific response from each of the plurality of users.

In general, in one aspect, the invention relates to a system that includes a plurality of computing devices used by a plurality of users of an organization, wherein each of the plurality of computing devices displays a standby screen to a corresponding user of the plurality of users, a standby screen management engine that displays, within the standby screen displayed on each of the plurality of computing devices, a message that prompts a user-specific response from the corresponding user, and receives, in response to displaying the message and from the plurality of computing devices, the user-specific response from at least one responding user of the plurality of users, a user response analysis engine that generates a result by at least analyzing the user-specific response from the at least one responding user, a feedback operation engine that performs, based on the result, a feedback operation of the organization, wherein the feedback operation comprises dynamically adjusting the message for subsequent displaying within the standby screen to prompt a subsequent user-specific response from each of the plurality of users, and a computer network of the organization that couples the plurality of computing devices, the standby screen management engine, the user response analysis engine, and the feedback operation engine.

Other aspects and advantages will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIGS. 1A-1B show a system in accordance with one or more embodiments.

FIGS. 2 and 3A show flowcharts in accordance with one or more embodiments.

FIG. 3B shows an example in accordance with one or more embodiments.

FIG. 4 shows a computing system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Embodiments of this disclosure provide a method and system for bi-directional communication using a standby screen. In one or more embodiments of the invention, a message is displayed within the standby screen displayed on each of a number of computing devices used by users of an organization. The message prompts a user-specific response from each user. In response to displaying the message, the user-specific response is received from at least one responding user among all users. A result is then generated by at least analyzing the user-specific response from the responding user(s). Accordingly, a feedback operation of the organization is performed based on the result. Further, in connection with receiving the user-specific response, a user-inputted password is received via a password input field of the standby screen. The user-inputted password is validated to allow the at least one responding user accessing a corresponding computing device. During the time from displaying the message until validating the user-inputted password, the standby screen is continuously displayed on the corresponding computing device such that the user may respond to the message at any time prior to inputting the password.

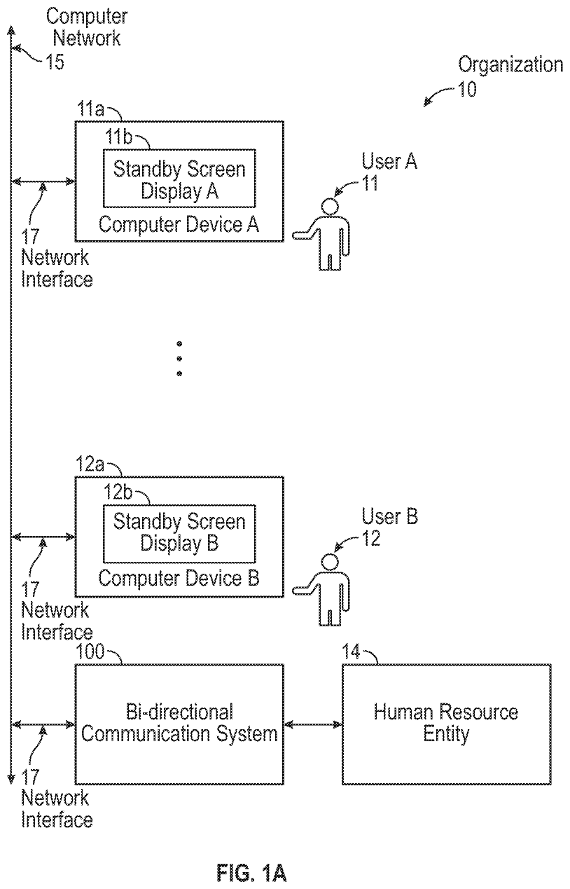

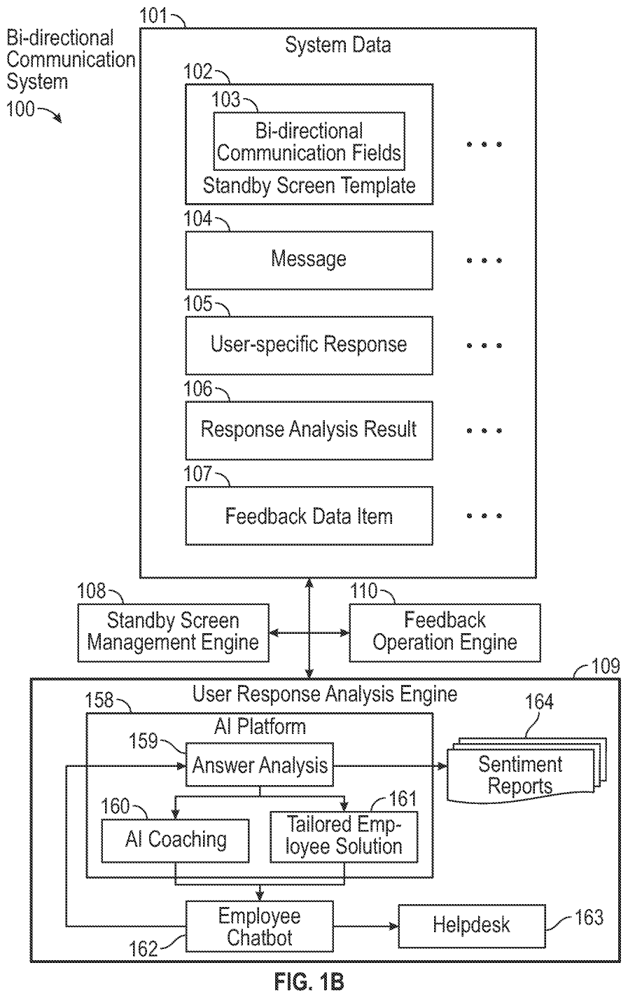

FIG. 1A shows an organization (10) in accordance with one or more embodiments of the invention. As shown in FIG. 1A, the organization (10) includes users (e.g., user A (11), user B (12)) using respective computer devices (e.g., computer device A (11a), computer device, B (12a)) that are able to display standby screens (e.g., standby screen display A (11b), standby screen display (12b)). In addition, the organization (10) includes a bi-directional communication system (100) used or otherwise managed by a human resource entity (14) of the organization (10). Further, computer devices (e.g., computer device A (11a), computer device, B (12a)) and the bi-directional communication system (100) are coupled to each other via a computer network (15) of any size having wired and/or wireless segments.

In one or more embodiments, the computer network (15) is an enterprise network consists of physical and virtual networks and protocols that connect all users and systems to applications in a data center of the organization (10) and cloud computing resource. The computer network (15) may be wired, wireless, or a combination thereof. The computer network (15) includes a network interface (17) configured to bi-directionally communicate with device interfaces (not shown) of the plurality of computer devices. In the computer network (15), the computer devices (e.g., computer device A (11a), computer device, B (12a)) and the bi-directional communication system (100) are coupled to each other via switches, routers, and ethernet or WIFI connections to share applications and data. Users typically need to establish accounts for secure access. Enterprises often run VPN software that encrypts user data when connecting to websites or servers outside of a local area network (LAN).

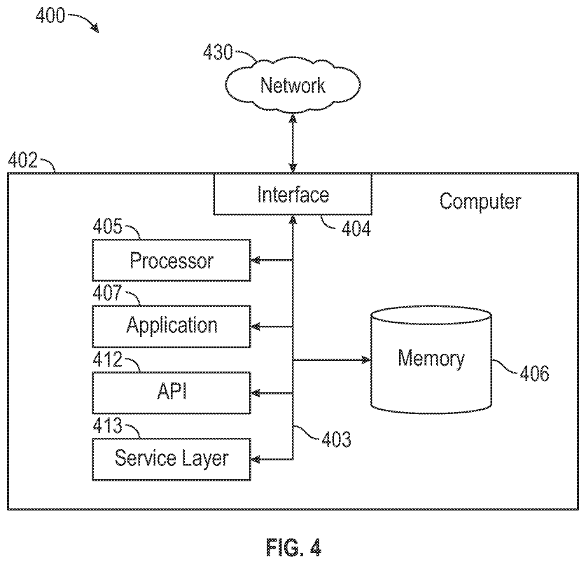

In one or more embodiments, the organization (10) is a business entity where the users (e.g., user A (11), user B (12)) are employees of the business entity. For example, the bi-directional communication system (100) may be used by the human resource department of the business entity to facilitate communication with the employees for surveying employee mindsets and providing support services. Each of these components (11a, 11b, 100) may correspond to a personal computer (PC), laptop, tablet PC, smart phone, multifunction printer, kiosk, server, etc. In one or more embodiments, these components may be implemented using the computing system (400) described below in reference to FIG. 4. Details of the bi-directional communication system (100) are described below.

FIG. 1B shows a bi-directional communication system (100) in accordance with one or more embodiments of the invention. As shown in FIG. 1B, the bi-directional communication system (100) has multiple components, including, for example, system data (101), a standby screen management engine (108), a user response analysis engine (109), and a feedback operation engine (110). Each of these components (101, 108, 109, 110) may be located on the same computing device (e.g., personal computer (PC), laptop, tablet PC, smart phone, multifunction printer, kiosk, server, etc.) or on different computing devices connected by a network of any size having wired and/or wireless segments. In one or more embodiments, these components may be implemented using the computing system (400) described below in reference to FIG. 4. Each of these components is discussed below.

In one or more embodiments, the system data (101) may be stored in a repository implemented in hardware (i.e., circuitry), software, or any combination thereof. The system data (101) includes data that are generated or used by the standby screen management engine (108), the user response analysis engine (109), and the feedback operation engine (110). In one or more embodiments, the stored data includes standby screen templates (e.g., standby screen template (102)), messages (e.g., message (104)), user-specific responses (e.g., user-specific response (105)), response analysis results (e.g., response analysis result (106), and feedback data items (e.g., feedback data item (107)), which are described in detail below. The system data (101) further stores the intermediate and final results of the bi-directional communication system (100) that are directly or indirectly derived from or related to the standby screens, messages, user-specific responses, response analysis results, and feedback data items described above.

The standby screen template (102) may be any template for a standby screen including but not limited to a screensaver image, lock screen, home screen, start-up screen, and/or computer display background that is displayed, e.g., as a pixel-based image, on a computing device screen used by a particular user. The template includes information regarding the layout and content of such standby screens. The computing device may be anyone of a personal computer (PC), laptop, tablet PC, smart phone, multifunction printer, kiosk, or similar devices used by the user. Different users may use different types of the computing device throughout the organization. In one or more embodiments, the standby screens for different users may correspond to different types of standby screens. In other words, the standby screen displayed on one user's computing device screen may be a screen saver image, while the standby screen displayed on another user's computing device screen may be a different type of the standby screen, such as a lock screen, home screen, start-up screen, and/or computer display background.

In one or more embodiments, each standby screen includes bi-directional communication fields (e.g., bi-directional communication fields (103)), such as a display filed for displaying a message (e.g., message (104)) and an input field for receiving a user provided response (e.g., user-specific response (105)). In one or more embodiments, the message (e.g., message (104)) includes a text or graphics object that prompts a user-specific response from each user viewing the respective standby screen. In one or more embodiments, same messages are displayed within all standby screens of all users. For example, the message may present a question such as “How do you feel today?” or “Are you aware of the new employee benefit just becoming available?”. In one or more embodiments, the message corresponds to an inquiry from a service entity of the organization seeking feedback from the users.

The user-specific response (e.g., user-specific response (105)) is a user provided input in response to being prompted by the message (e.g., message (104)). In one or more embodiments, the user-specific response (e.g., user-specific response (105)) includes a phrase, a sentence, a graphic icon, or other textual or graphic input that is created or selected by the user. For example, the response may be entered into the input field or selected from a selection menu included in the input field. For example, the user-specific response may represent a sentiment or a need for service such as “I feel tired today” or “I am not aware of the new employee benefit”. The user who create or select one or more response is referred to as a responding user. The user who does not create or select any response is referred to as a non-responding user.

The response analysis result (e.g., response analysis result (106)) is an output of analyzing the received user-specific response(s). In one or more embodiments, the response analysis result (e.g., response analysis result (106)) may include a survey report specific to a particular user or include survey information of multiple or all users. For example, the survey report may indicate how often a particular user feels tired when prompted, or how many users are not aware of the new employee benefit. In one or more embodiments, the response analysis result includes a user-specific recommendation, such as “Please relax and have a cup of coffee in the company lounge” or “Please click on the following link to learn more about the new employee benefit.” In one or more embodiments, the response analysis result includes determining a needed adjustment of the message, e.g., to improve the relevance of received responses.

The feedback data item (e.g., feedback data item (107)) is one or more data items that are used to perform a feedback operation based on the response analysis result. In one or more embodiments, the feedback data item corresponds to or is derived from the response analysis result, such as the survey report, the recommendation, and/or the needed adjustment. In one or more embodiments, the feedback data item corresponds to a summarized information derived from the response analysis result that is provided to the service entity of the organization seeking feedback from the users.

In one or more embodiments, the standby screen management engine (108) may be implemented in hardware (i.e., circuitry), software, or any combination thereof. The standby screen management engine (108) is configured to insert, within the standby screen displayed on each computing device, a message that prompts a user-specific response from the corresponding user. The standby screen management engine (108) is further configured to receive, from the computing devices and in response to displaying the message, user-specific response(s) from at least one responding user among all users. In one or more embodiments, the standby screen management engine (108) includes a chatbot to present the message to all users and receive user-specific response(s) from responding user(s). The chatbot is a computer program designed to simulate conversation with human users.

In one or more embodiments, the standby screen management engine (108) displays, on a corporate screensaver via an internal information technology (IT) network, a message such as a weekly coaching question designed to allow the employee to reflect on the given topic created from a manual entry by a human resource specialist or automatically selected from a question database. Each employees is given the option to answer the question on a digital interface's employee response field while log-in to the computer. The answers or other responses are collected into a database as input to an AI platform for analysis by the user response analysis engine (109).

In one or more embodiments, the user response analysis engine (109) may be implemented in hardware (i.e., circuitry), software, or any combination thereof. The user response analysis engine (109) is configured to generate a result by at least analyzing the user-specific response(s) from the responding user(s). In one or more embodiments, the user response analysis engine (109) includes an artificial intelligence (AI) platform (158) that performs answer analysis (159) to generate a conversation with the employee via a chatbot (162) regarding coaching (160) and tailored solution (161) which acts as an automated helpdesk (163). Based on the conversation and as the tailored solution, the AI platform (158) recommends the most appropriate development and support services available within the company's training and development portfolio for the employee to act upon. An optional journal may be provided that allows the employee to document insights and enhance reflections. The process is designed to be anonymous with built-in encryption features, e.g., of the system data (101). The AI platform (158) also generates sentiment reports (164), which provides agile continuous analysis on trends observed in various segments of the organization. In one or more embodiments, The AI platform (158) generates future questions that are reviewed or otherwise processed through an administrative filtration process before being added to the question database.

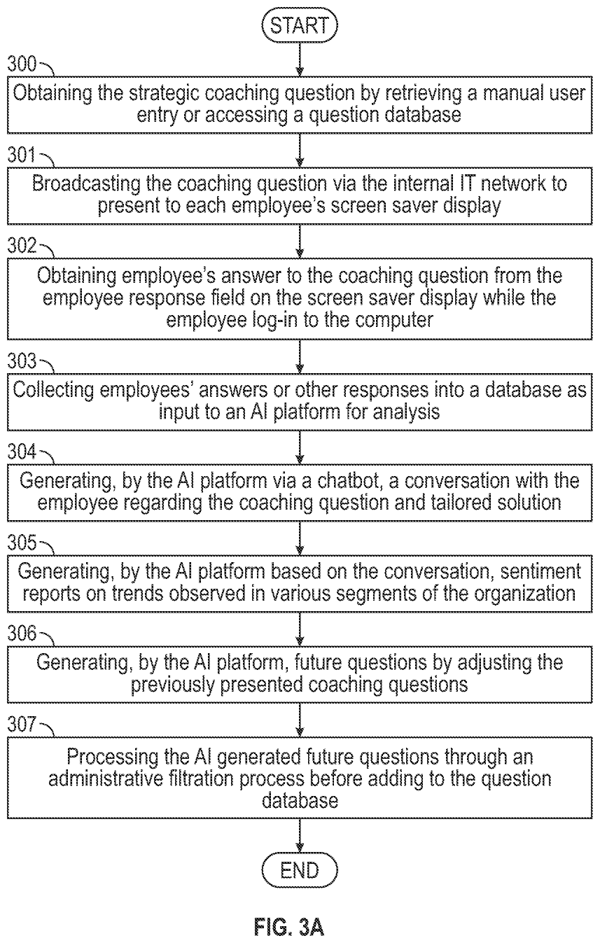

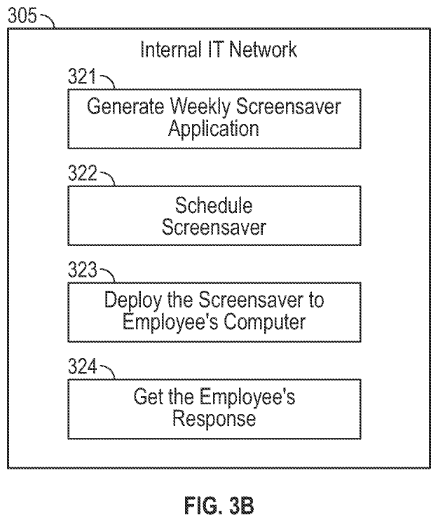

As described in further details in reference to FIGS. 3A-3B below, the AI platform (158) may include recommendation engines, such as a collaborative filtering based recommender, content based recommender, or hybrid-based recommender combining both collaborative filtering and content-based filtering. These recommendation engines are built using machine learning algorithms including but not limited to K-Nearest Neighbor (KNN), Stochastic Gradient Descent (SGD), Non-negative Matrix Factorizations, Singular Vector Decomposition (SVD), Alternating Least Squares (ALS), Neural Collaborative Filtering (NCF—using Deep Neural Network), and Bayesian Personalized Ranking (BPR). Additional example functionalities of each component of the AI platform (158) are also described in reference to FIGS. 3A-3B below.

In one or more embodiments, the feedback operation engine (110) may be implemented in hardware (i.e., circuitry), software, or any combination thereof. The feedback operation engine (110) is configured to perform, based on the result, a feedback operation of the organization.

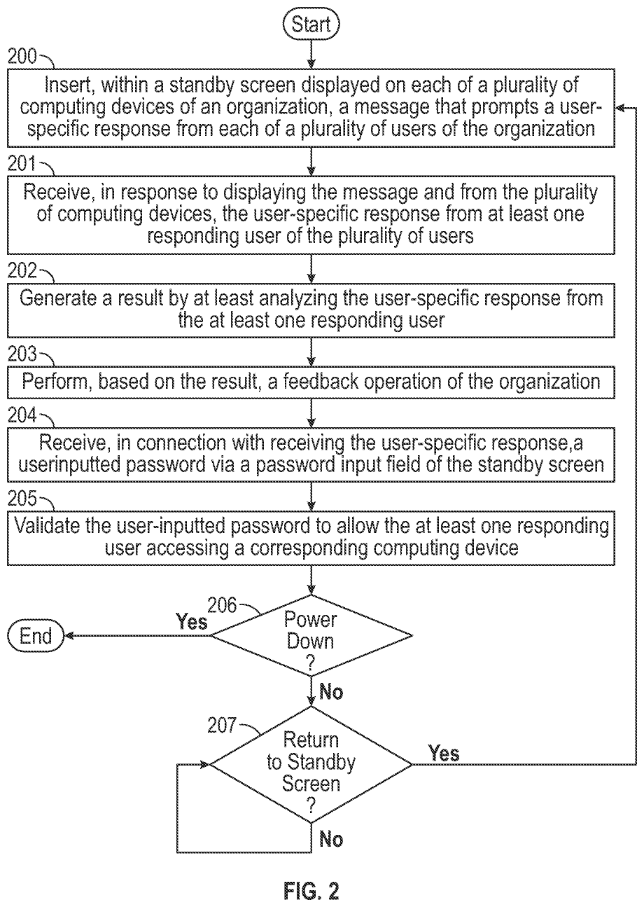

In one or more embodiments, the bi-directional communication system (100) performs the functions described above using the method described below in reference to FIG. 2. An example of the bi-directional communication system (100) is described in reference to FIGS. 3A and 3B below.

Although the bi-directional communication system (100) is shown as having four components (101, 108, 109, 110), in one or more embodiments of the invention, the bi-directional communication system (100) may have more or fewer components. Furthermore, the functions of each component described above may be split across components. Further still, each component (101, 108, 109, 110) may be utilized multiple times to carry out an iterative operation.

FIG. 2 shows a flowchart in accordance with one or more embodiments disclosed herein. In one or more embodiments, the flowchart relates to a method using a standby screen for bi-directional communication between users within an organization and a service entity of the organization. For example, the organization may be a business entity such as a company, the users may be employees of the business entity, and the service entity may be a human resource (HR) department within the business entity. One or more of the steps in FIG. 2 may be performed by one or more components of the bi-directional communication system (100), discussed above in reference to FIG. 1B. In one or more embodiments, one or more of the steps shown in FIG. 2 may be omitted, repeated, and/or performed in a different order than the order shown in FIG. 2. Accordingly, the scope of the disclosure should not be considered limited to the specific arrangement of steps shown in FIG. 2.

Initially in Block 200, a message is displayed within a standby screen displayed on each of a number of computing devices used by users of an organization. The standby screen is displayed according to a standby screen template broadcasted across a computer network of the organization. The message prompts a user-specific response from each of the users of the organization. In one or more embodiments, the same messages are displayed within all standby screens of all users.

In Block 201, in response to displaying the message, the user-specific response is received from at least one responding user among all the users.

In Block 202, a result is generated by at least analyzing the user-specific response from at least one responding user. For example, the result may correspond to the response analysis result (106) described in reference to FIG. 1B above. In particular, the result may be in the form of a survey report regarding the user or a recommendation provided to the user. In one or more embodiments, multiple users respond to the messages displayed on respective computing device interfaces within a pre-determined time duration (e.g., one hour, one day, one week, etc.) and the result is generated by analyzing the collection of all user-specific responses from all responding users. During the pre-determined time duration, one or more users may provide multiple user-specific responses that are included in the collection of all user-specific responses for analysis.

In Block 203, a feedback operation of the organization is performed based on the result. In one or more embodiments, the feedback operation involves dynamically adjusting the message displayed to the user on the user's screen saver. Further, the feedback operation may also include sending the survey report to the service entity of the organization. As described in reference to FIG. 1B above, the survey report may indicate how often a particular user feels tired when prompted, or how many users are not aware of the new employee benefit. In one or more embodiments, the feedback operation includes generating and presenting a user-specific recommendation to each responding user. For example, a user-specific need for service may be detected from a responding user by analyzing the response. Accordingly, the user-specific recommendation is generated based on the detected user-specific need for service.

In one or more embodiments, the feedback operation includes dynamically adjusting the message for subsequent displaying within the standby screen to prompt a subsequent user-specific response from each users. In such embodiments, the user-specific response and the subsequent user-specific responses from each user are collected over time to form an artificial intelligence (AI) data set. For example, the AI data set may be used as an input to an AI algorithm that facilitates the analysis of Block 202 to generate subsequent results. As more user-specific responses are collected into the AI data set, the efficacies of the result and the feedback operation are improved. In one or more embodiments, performing the feedback operation shortens the latency and increases the efficacy of deploying employee development services in the organization. Accordingly, performing the feedback operation improves the target results of the organization. As noted above, the development service is any service available within the organization to facilitate the employees to perform work assignments and/or to improve employees' contributions to target results of the organization. For example, the target results of a business entity may include product development results, sales promotion results, customer satisfaction results, manufacturing efficiency results, etc. The latency is the time after a particular development service is made available within the organization, e.g., by the human resource department, till an anticipated portion (e.g., 20%) of employees are inquiring about or accessing the deployed service. The latency is the portion (e.g., 50%) of employees who are accessing the deployed service after the latency period.

In one or more embodiments, displaying the message and receiving the user-specific response are performed using a chatbot where the chatbot is controlled by the AI algorithm to perform the bi-directional communication via the standby screen between the users and the service entity of the organization. For example, the survey reports, the user-specific recommendations, and/or the adjusted messages may be sent to the service entity and are reviewed, generated, fine-tuned, or otherwise processed by the service entity.

In Block 204, a user-inputted password is received via a password input field of the standby screen to unlock the standby screen for accessing the computing device to use installed applications. In one scenario, the user-inputted password is received from a responding user in connection with receiving the user-specific response. In another scenario, the user-inputted password is received from a non-responding user without receiving any user-specific response.

In one or more embodiments, the user-specific response is entered by the responding user prior to entering the user-inputted password but only received by the system after the user-inputted password is validated for privacy and authentication considerations. In one or more embodiments, the input field for receiving user provided response is initially displayed within the standby screen and persists after the user-inputted password is validated. In such embodiments, the user has the option to enter the response either before or after the user-inputted password is validated.

In Block 205, user-inputted password is validated to allow either the responding user or the non-responding user to access a corresponding computing device. In one or more embodiments, the user-inputted password is validated based on system authentication credentials of the user. The standby screen is continuously displayed on the corresponding computing device from initially displaying the message until validating the user-inputted password. In one or more embodiments, upon validating the user-inputted password, the standby screen is replaced by another screen that does not include any previously displayed message. In other words, the displayed message is removed from the screen of the computing device once the user-inputted password is validated. In one or more embodiments, the initially displayed message persists after the user-inputted password is validated. In other words, the displayed message remains displayed on the screen of the computing device for some time after the user-inputted password is validated.

In Block 206, a determination is made as to whether to power down the computer device. For example, the determination may be based on a user command to turn off the computer device. If the determination is positive, i.e., the computing device is to power down, the method ends. If the determination is negative, i.e., the computing device is not to power down, the method proceeds to Block 207.

In Block 207, a determination is made as to whether the computing device returns to displaying the standby screen. For example, the determination may be based on a user command to display the standby screen or a system timer to cause the computer device to enter a sleep mode. In one or more embodiments, the determination is made specific to each computing device. If the determination is positive, i.e., the computing device is to return to displaying the standby screen, the method returns to Block 200. If the determination is negative, i.e., the computing device is not to return to displaying the standby screen, the method returns to Block 207.

FIGS. 3A-3B show an example in accordance with one or more embodiments. In particular, FIG. 3A shows a flowchart describing the method from the perspective of the AI platform. FIG. 3B shows an example of using the standby screen for bi-directional communication between users and a service entity of an organization as described in reference to FIGS. 1-2 above. In one or more embodiments, one or more of the modules and/or elements shown in FIGS. 3A-3B may be omitted, repeated, combined and/or substituted. Accordingly, embodiments disclosed herein should not be considered limited to the specific arrangements of modules and/or elements shown in FIGS. 3A-3B.

The example relates to a scalable, automated and continuous method implemented in an organization for achieving the objectives of influencing corporate culture, detecting employee sentiment, and recommending the most appropriate development and support services through a single technology-based process. The example leverages modern Artificial Intelligence (AI) technology, with existing underutilized features including the corporate PC screensaver and digital HR advisor avatar chatbot, to combine with the principles of coaching psychology to deliver the above objectives.

FIG. 3A shows a schematic process diagram of the example process. As shown in FIG. 3A, initially in Block 300, the strategic coaching question is obtained by retrieving a manual user entry or accessing a question database. In Block 301, the coaching question is broadcasted via the internal information technology (IT) network to present to each employee's screensaver display. In Block 302, the employee's answer to the coaching question is obtained from the employee response field on the screensaver display while the employee log-in to the computer. In Block 303, the employees' answers or other responses are collected into a database as input to an AI platform for analysis. For example, other responses may be collected from an optional journal that allows the employees to document insights and enhance reflections. The collection process is anonymous with built-in encryption features of the database. In Block 304, the AI platform generates a conversation with the employee regarding the coaching question and tailored solution via a chatbot, which acts as an automated helpdesk. In Block 305, based on the conversation, the AI platform generates sentiment reports, which provide agile continuous analysis on trends observed in various segments of the organization. In addition in Block 306, the AI platform also generates future questions by adjusting the previously presented coaching questions. In Block 307, the AI generated future questions are reviewed or otherwise processed through an administrative filtration process before being added to the question database.

The process block diagram described above highlights the following key aspects of the example process.

### 1. Dynamic Approach to Tailored Recommendation of Development Services

In a typical organization, an employee may not be aware of what development services are available to them, what interventive actions may be most appropriate for them at a given time, and/or where and how to access the development services and perform interventive actions.

Assessing and recommending development services based on individual needs at the right time is more effective than an off-the-shelf approach. However, delivery of individual recommendations by an HR advisor can be constrained by limited resources, particularly in medium and large sized corporations.

This process bridges these constraints by using a technology-based approach to connect employees with matched development services in a scalable approach so as to free-up HR advisors to focus on actual delivery of the matched services.

2. Artificial Intelligence with Integrated Chatbot

The process uses AI algorithms to analyze employee responses to the strategic coaching question, as well as other interactions in the Chatbot interface, to select and recommend to the employee the appropriate support and development services that are available to them and are suitable for their needs. The AI algorithms here refer to Recommendation Engines. Recommendation Engine systems may include the following three types.
1—Collaborative Filtering based Recommenders: implemented using an item-item approach and a user-user approach. Here the items are the list of support and development services available to employees, and the users are employees.
2—Content Based Recommenders: implemented using the description of the items and the profile of the users. Here the items are the list of support and development services available to employees, and the users are employees.
3—Hybrid Based recommenders: combining both Collaborative Filtering and Content-Based Filtering.

These three recommenders are built using the machine learning algorithms including but not limited to K-Nearest Neighbor (KNN), Stochastic Gradient Descent (SGD), Non-negative Matrix Factorizations, Singular Vector Decomposition (SVD), Alternating Least Squares (ALS), Neural Collaborative Filtering (NCF—using a Deep Neural Network), and Bayesian Personalized Ranking (BPR).

A database of available internal services, including coaching, training, counselling or other solutions offered by the company's management and professional development department is provided as an input to the AI system.

A custom conversational AI solution or language model is used to generate questions based on employee responses to establish a dialog system. Once the database is established, employee data can be updated and retrieved securely, and the machine learning and AI algorithms will generate recommendations for each employee.

A custom chatbot is equipped with a predefined question and answer dataset. The chatbot may be integrated with realistic features such as a human face and expressions or digital avatar to improve communications effectiveness.

### 3. Data Privacy and Security

In order for employees to trust that their data will be treated confidentially, the process is equipped with robust encryption and de-identification features. Employee data are encrypted and stored in a secure database specifically established for this solution.

Searchable Encryption can be used to search over the encrypted employee data to protect the confidentiality/privacy, without learning the content of the record or queries. Information from the database used to generate trend analysis and reports will have identifications removed to ensure anonymity. Encrypted employee data can only be decrypted by authorized access and functions.

The system complies with all applicable data privacy and protection regulations and align with General Data Protection Regulation (GDPR). Server architecture also complies with statutory regulations applicable to the user organization.

### 4. Gathering Data Through Use of Strategic Coaching Questions

A repository (e.g., question database) of thought-provoking questions is developed to either detect employee emotional state in relation to a specific event, or influence that sentiment by evoking positive emotions. Positive emotions open up new possibilities, enhance performance and overall wellbeing. Appreciative inquiry or strengths-based questions have been proven to evoke positive emotions and mindsets. An example of a sentiment detecting question could be “How are you feeling about your goals this year?”. An examples of appreciative inquiry question could be “Which achievement over the past year are you most proud of?” or “What could lift your energy when you are feeling low?”.

### 5. Unique Way of Data Gathering: Corporate Screensaver Broadcast

Another challenge that large corporations face is having one simple system of communication that is easily accessible to all employees. Company-wide announcements distributed via traditional push-pull communication methods such as email, intranet bulletins etc., are often received but not read.

The example method leverages the existing, yet underutilized technology of PC/laptop screensavers. Screensavers were originally developed to prevent physical damage in old-style cathode ray tube monitors. However, such protection is not required for modern screens. Many companies with an internal network use a default screensaver, without serving any purpose other than a photo for visual appeal, or otherwise a blank screen.

The example method uses the corporate screensaver feature to broadcast one strategically developed question on a weekly basis. This question is intended to be the basis for personal reflection, an enabler for deeper and more meaningful conversations between employees, and an opportunity to intentionally design corporate discourse, while at the same time giving opportunity to employees to have a brief coaching moment.

The screen displays the strategic question in an efficient and non-obtrusive manner, which the employee sees prior to entering a password to log in. Idle standby screens throughout the offices reinforce the question and promote discussion among employees. The information to be broadcast on the corporate screensaver is of a non-confidential nature and comply with the organization's data security policies.

An example of corporate screensaver broadcast is illustrated in FIG. 3B. FIG. 3B shows a schematic block diagram of the example corporate screensaver broadcast platform implemented across the internal IT network of the organization. As shown in FIG. 3B, in Block 321, a weekly screensaver application is generated that accesses messages (e.g., coaching questions) from a database or manual entry. In Block 322, the displayed coaching questions are updated according to a weekly schedule. In Block 323, the screensaver is deployed to employee's computers In Block 324, the displayed coaching question in the deployed screensaver prompts for response from the employee who has the following response options: (i) to provide a typed response, (ii) defer to later when the coaching question will be presented to the user again, for example, the next time the user logs in, and (iii) no response, in which case the same coaching question will not be presented to the user again. In the first option, the typed response is encrypted and sent to the AI database for AI analysis.

### 6. Optional Personal Journal

Employees have an option to save their response entries as their journal (e.g., employee journal) for personal reference that marks their mood at the time of entry. This is a useful feedback loop for the employee, triggering a deeper level of self-awareness. Journaling has been found to have a range of benefits, including improve mental health and well-being, encourage self-confidence, boost emotional intelligence, help with achieving goals, inspire creativity, boost memory, and enhance critical thinking skills and performance. The example process provides journaling as a corporate tool to support employee well-being and performance.

### 7. Sentiment Reports

In many corporations, the most commonly used approaches to gathering data regarding employee sentiment are annual engagement surveys or more frequently conducted pulse surveys. However, annual survey results can be impacted by many factors such as primacy and recency effects, not giving a complete view of employee sentiment. Furthermore, given the time needed for analysis, the findings may no longer be relevant.

The example process provides a new and more agile approach for data gathering and analysis to overcome the challenges related to a fast-changing work environment. The AI platform is used to develop sentiment reports, which provides anonymous analysis on a weekly or monthly basis. From the analysis in the reports, organizational trends are detected in various segments of organization such as departments or divisions. This moment to moment automatically generated reports provide insights to facilitate decision making and enable intentional design of organizational culture.

### 8. Scalable Way to Influencing Corporate Culture

Corporate Culture is considered a key element to successful implementation of corporate strategy. Studies show that the “Millennial” generation, currently the largest demographics, values company culture above all other organizational attributes. The example process enables an ongoing culture audit and a scalable way of influencing employees' mindset through the principle of coaching psychology and delivered through adaptive technology. In this manner, the example process produces positive impact on company brand, image, people development, and attraction and retention of top talent.

Embodiments may be implemented on a computer system. FIG. 4 is a block diagram of a computer system (400) used to provide computational functionalities associated with described algorithms, methods, functions, processes, flows, and procedures as described in the instant disclosure, according to an implementation. The illustrated computer (402) is intended to encompass any computing device such as a high-performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (402) may include a computer that includes an input device, such as a keypad, keyboard, touch screen, or other device that can accept user information, and an output device that conveys information associated with the operation of the computer (402), including digital data, visual, or audio information (or a combination of information), or a GUI.

The computer (402) can serve in a role as a client, network component, a server, a database or other persistency, or any other component (or a combination of roles) of a computer system for performing the subject matter described in the instant disclosure. The illustrated computer (402) is communicably coupled with a network (430). In some implementations, one or more components of the computer (402) may be configured to operate within environments, including cloud-computing-based, local, global, or other environment (or a combination of environments).

At a high level, the computer (402) is an electronic computing device operable to receive, transmit, process, store, or manage data and information associated with the described subject matter. According to some implementations, the computer (402) may also include or be communicably coupled with an application server, e-mail server, web server, caching server, streaming data server, business intelligence (BI) server, or other server (or a combination of servers).

The computer (402) can receive requests over network (430) from a client application (for example, executing on another computer (402)) and responding to the received requests by processing the said requests in an appropriate software application. In addition, requests may also be sent to the computer (402) from internal users (for example, from a command console or by other appropriate access method), external or third-parties, other automated applications, as well as any other appropriate entities, individuals, systems, or computers.

Each of the components of the computer (402) can communicate using a system bus (403). In some implementations, any or all of the components of the computer (402), both hardware or software (or a combination of hardware and software), may interface with each other or the interface (404) (or a combination of both) over the system bus (403) using an application programming interface (API) (412) or a service layer (413) (or a combination of the API (412) and service layer (413). The API (412) may include specifications for routines, data structures, and object classes. The API (412) may be either computer-language independent or dependent and refer to a complete interface, a single function, or even a set of APIs. The service layer (413) provides software services to the computer (402) or other components (whether or not illustrated) that are communicably coupled to the computer (402). The functionality of the computer (402) may be accessible for all service consumers using this service layer. Software services, such as those provided by the service layer (413), provide reusable, defined business functionalities through a defined interface. For example, the interface may be software written in JAVA, C++, or other suitable language providing data in extensible markup language (XML) format or other suitable format. While illustrated as an integrated component of the computer (402), alternative implementations may illustrate the API (412) or the service layer (413) as stand-alone components in relation to other components of the computer (402) or other components (whether or not illustrated) that are communicably coupled to the computer (402). Moreover, any or all parts of the API (412) or the service layer (413) may be implemented as child or sub-modules of another software module, enterprise application, or hardware module without departing from the scope of this disclosure.

The computer (402) includes an interface (404). Although illustrated as a single interface (404) in FIG. 4, two or more interfaces (404) may be used according to particular needs, desires, or particular implementations of the computer (402). The interface (404) is used by the computer (402) for communicating with other systems in a distributed environment that are connected to the network (430). Generally, the interface (404) includes logic encoded in software or hardware (or a combination of software and hardware) and operable to communicate with the network (430). More specifically, the interface (404) may include software supporting one or more communication protocols associated with communications such that the network (430) or interface's hardware is operable to communicate physical signals within and outside of the illustrated computer (402).

The computer (402) includes at least one computer processor (405). Although illustrated as a single computer processor (405) in FIG. 4, two or more processors may be used according to particular needs, desires, or particular implementations of the computer (402). Generally, the computer processor (405) executes instructions and manipulates data to perform the operations of the computer (402) and any algorithms, methods, functions, processes, flows, and procedures as described in the instant disclosure.

The computer (402) also includes a memory (406) that holds data for the computer (402) or other components (or a combination of both) that can be connected to the network (430). For example, memory (406) can be a database storing data consistent with this disclosure. Although illustrated as a single memory (406) in FIG. 4, two or more memories may be used according to particular needs, desires, or particular implementations of the computer (402) and the described functionality. While memory (406) is illustrated as an integral component of the computer (402), in alternative implementations, memory (406) can be external to the computer (402).

The application (407) is an algorithmic software engine providing functionality according to particular needs, desires, or particular implementations of the computer (402), particularly with respect to functionality described in this disclosure. For example, application (407) can serve as one or more components, modules, applications, etc. Further, although illustrated as a single application (407), the application (407) may be implemented as multiple applications (407) on the computer (402). In addition, although illustrated as integral to the computer (402), in alternative implementations, the application (407) can be external to the computer (402).

There may be any number of computers (402) associated with, or external to, a computer system containing computer (402), each computer (402) communicating over network (430). Further, the term “client,” “user,” and other appropriate terminology may be used interchangeably as appropriate without departing from the scope of this disclosure. Moreover, this disclosure contemplates that many users may use one computer (402), or that one user may use multiple computers (402).

In some embodiments, the computer (402) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, cloud computing system may operate according to one or more service models, such as infrastructure as a service (IaaS), platform as a service (PaaS), software as a service (SaaS), mobile “backend” as a service (MBaaS), serverless computing, artificial intelligence (AI) as a service (AIaaS), and/or function as a service (FaaS).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method for bi-directional communication using a standby screen, comprising:
displaying, within the standby screen displayed on each of a plurality of computing devices of an organization, a message that prompts a user-specific response from each of a plurality of users of the organization;
receiving, in response to displaying the message and from the plurality of computing devices, the user-specific response from at least one responding user of the plurality of users;
generating a result by at least analyzing the user-specific response from the at least one responding user; and
performing, based on the result, a feedback operation comprising dynamically adjusting the message for subsequent displaying within the standby screen to prompt a subsequent user-specific response from each of the plurality of users.

2. The method of claim 1, further comprising:
receiving, in connection with receiving the user-specific response, a user-inputted password via a password input field of the standby screen;
validating the user-inputted password to allow the at least one responding user accessing a corresponding computing device; and
continuously displaying the standby screen on the corresponding computing device from initially displaying the message until validating the user-inputted password.

3. The method of claim 1,
wherein performing the feedback operation further comprises generating and presenting a user-specific recommendation to the at least one responding user.

4. The method of claim 3,
wherein analyzing the response comprises detecting a user-specific need for service from the at least one responding user, and
wherein the user-specific recommendation is generated based on the detected user-specific need for service.

5. The method of claim 1, further comprising:
receiving, in response to dynamically adjusting the message, a subsequent user-specific response from each of the plurality of users.

6. The method of claim 5, further comprising:
generating an artificial intelligence (AI) data set comprising the user-specific response and the subsequent user-specific response from each of the plurality of users;
generating a subsequent result by analyzing the AI data set using an AI algorithm; and
performing, based on the subsequent result, a subsequent feedback operation of the organization.

7. The method of claim 6,
wherein displaying the message and receiving the user-specific response are performed using a chatbot, and
wherein the chatbot is controlled by the AI algorithm to perform the bi-directional communication via the standby screen with the plurality of users.

8. The method of claim 1,
wherein performing the feedback operation further comprises generating a survey report for the organization.

9. A system for bi-directional communication using a standby screen, comprising, comprising:
a computer network of an organization that broadcasts a standby screen template to a plurality of computing devices of an organization, the computer network of the organization comprising a network interface;
the plurality of computing devices coupled to the computer network via the network interface, each of the plurality of computing devices comprising a corresponding device interface configured to bi-directionally communicate with the network interface and comprising functionality for:
displaying, via the network interface and based on the standby screen template, a standby screen on each of the plurality of computing devices;
displaying, via the network interface and within the standby screen, a message that prompts a user-specific response from each of a plurality of users of the organization; and
receiving, via the network interface and in response to displaying the message and from the plurality of computing devices, the user-specific response from at least one responding user of the plurality of users; and
an artificial intelligence (AI) platform comprising functionality for:
generating a result by at least analyzing the user-specific response from the at least one responding user; and
dynamically adjusting the message for subsequent displaying within the standby screen via each of the device interfaces to prompt a subsequent user-specific response from each of the plurality of users.

10. The system of claim 9, the plurality of computing devices further comprising functionality for:
receiving, in connection with receiving the user-specific response, a user-inputted password via a password input field of the standby screen;
validating the user-inputted password to allow the at least one responding user accessing a corresponding computing device; and
continuously displaying the standby screen on the corresponding computing device from initially displaying the message until validating the user-inputted password.

11. The system of claim 9,
wherein performing the feedback operation further comprises generating and presenting a user-specific recommendation to the at least one responding user.

12. The system of claim 11,
wherein analyzing the response comprises detecting a user-specific need for service from the at least one responding user, and
wherein the user-specific recommendation is generated based on the detected user-specific need for service.

13. The system of claim 9,
wherein performing the feedback operation further comprises adjusting the message for subsequent displaying within the standby screen to prompt a subsequent user-specific response from each of the plurality of users.

14. The system of claim 13, the AI platform further comprising functionality for:
generating an artificial intelligence (AI) data set comprising the user-specific response and the subsequent user-specific response from each of the plurality of users;
generating a subsequent result by analyzing the AI data set using an AI algorithm; and
performing, based on the subsequent result, a subsequent feedback operation of the organization.

15. The system of claim 14,
wherein displaying the message and receiving the user-specific response are performed using a chatbot, and
wherein the chatbot is controlled by the AI algorithm to perform the bi-directional communication via the standby screen with the plurality of users.

16. The system of claim 9,
wherein performing the feedback operation further comprises generating a survey report for the organization.

17. A system comprising:
a plurality of computing devices used by a plurality of users of an organization, wherein each of the plurality of computing devices displays a standby screen to a corresponding user of the plurality of users;
a standby screen management engine that
displays, within the standby screen displayed on each of the plurality of computing devices, a message that prompts a user-specific response from the corresponding user; and
receives, in response to displaying the message and from the plurality of computing devices, the user-specific response from at least one responding user of the plurality of users;
a user response analysis engine that generates a result by at least analyzing the user-specific response from the at least one responding user;
a feedback operation engine that performs, based on the result, a feedback operation of the organization comprising dynamically adjusting the message for subsequent displaying within the standby screen to prompt a subsequent user-specific response from each of the plurality of users; and
a computer network of the organization that couples the plurality of computing devices, the standby screen management engine, the user response analysis engine, and the feedback operation engine.

18. The system of claim 17, wherein the standby screen management engine further
receives, in connection with receiving the user-specific response, a user-inputted password via a password input field of the standby screen;
validates the user-inputted password to allow the at least one responding user accessing a corresponding computing device; and
continuously displays the standby screen on the corresponding computing device from initially displaying the message until validating the user-inputted password.

19. The system of claim 17, wherein performing the feedback operation further comprises one or more of
generating and presenting a user-specific recommendation to the at least one responding user, and
generating a survey report for the organization.

20. The system of claim 17,
wherein the standby screen management engine comprises a chatbot,
wherein the user response analysis engine comprises an artificial intelligence (AI) algorithm, and
wherein the chatbot is controlled by the AI algorithm to perform bi-directional communication via the standby screen with the plurality of users.
